(19) United States
(12) Patent Application Publication
(10) Pub. No.: US 2008/0089477 A1
(43) Pub. Date: Apr. 17, 2008

(54) System and method for security of shipped containers

(76) Inventors: Eyal Eshed, Mazor (IL); John H. Beardslee, The Woodlands, TX (US); Ben Kidron, Herzlia (IL); Yaron Caspi, Ness Ziona (IL)

Correspondence Address: Pearl Cohen Zedek Latzer, LLP, 1500 Broadway, 12th Floor, New York, NY, 10036, US

(21) Appl. No.: 11/802,776

(22) Filed: May 24, 2007

Related U.S. Application Data
(60) Provisional application No. 60/808,159, filed on May 25, 2006.

(51) Int. Cl. G01N 23/04; G06K 9/62

(52) U.S. Cl. 378/57; 382/209

(57) ABSTRACT

A system and method of capturing an image in a first location of items in a shipping container, and comparing the image of the items to an image of items in the same container as was captured in a second location, to determine if the contents of the container had been altered.

### REFERENCE TO RELATED APPLICATIONS

This application claims the benefit of U.S. Provisional Patent Application 60/808,159, filed on May 25, 2006 entitled Security Through Image Comparison, a copy of which is hereby incorporated herein in its entirety by reference.

### FIELD OF THE INVENTION

Embodiments of the invention relate to security and inspection of shipped container or boxes, and particularly, to capturing images of a content of a container at various points on a shipping route, and comparing such images.

### BACKGROUND OF THE INVENTION

The security and integrity of shipped containers is drawing increased attention as a source of smuggling opportunities for contraband or taxed materials, and as an opportunity to bring dangerous materials into a populated area. There is a need to quickly and effectively check the integrity of a container such as a closed container to determine if the contents have been tampered with or altered, or if unauthorized materials have been put into the container at one or more points along a shipping route.

### SUMMARY OF THE INVENTION

Some embodiments of the invention may include a system having a first imager in a first location to capture an image of an item in a closed container from outside of the container, a second imager in a second location to capture an image of the item in the closed container, and a processor to compare the image of the item in the container in the first location to the image of the item in the container in the second location. In some embodiments the imager may be or include an X-ray emitter. In some embodiments, the container may include a unique identifier that appears in one or more of the images. In some embodiments the container contains many items and the processor determines if one or more of the items appears in the second image and does not appear in the first image. In some embodiments the image captured in the first location is communicated to the second location over a network. In some embodiments, the first image includes a unique identifier of the first location. In some embodiments the processor detects from the first image a pattern of some or all of the items in the container, and compares the pattern to a pattern in the second image. In some embodiments, the processor adjusts the second image to account for movement within the container of items between the first location and the second location.

Some embodiments of the invention may include a method of capturing with an imager located outside a closed container in a first location, a first image of an items in the container, capturing with an imager located outside a closed container in a second location, a second image of the items in the container, comparing the first image to the second image; and determining if items appearing in the second image were in the container in the first location. In some embodiments, the method may include collecting an X-ray image of the container. In some embodiments, the method may include associating in a data base, the first image with the container, and making the image accessible to an operator at the second or other location.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic depiction of a system in accordance with an embodiment of the invention;

FIG. 2 is a schematic depiction of an image of a container collected by a system in accordance with an embodiment of the invention; and

FIG. 3 is a flow diagram of a method in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more of the functions described in for example a method of the invention may be contained in a single device, while in other embodiments, one or more of such components may be stored or executed from more than one device.

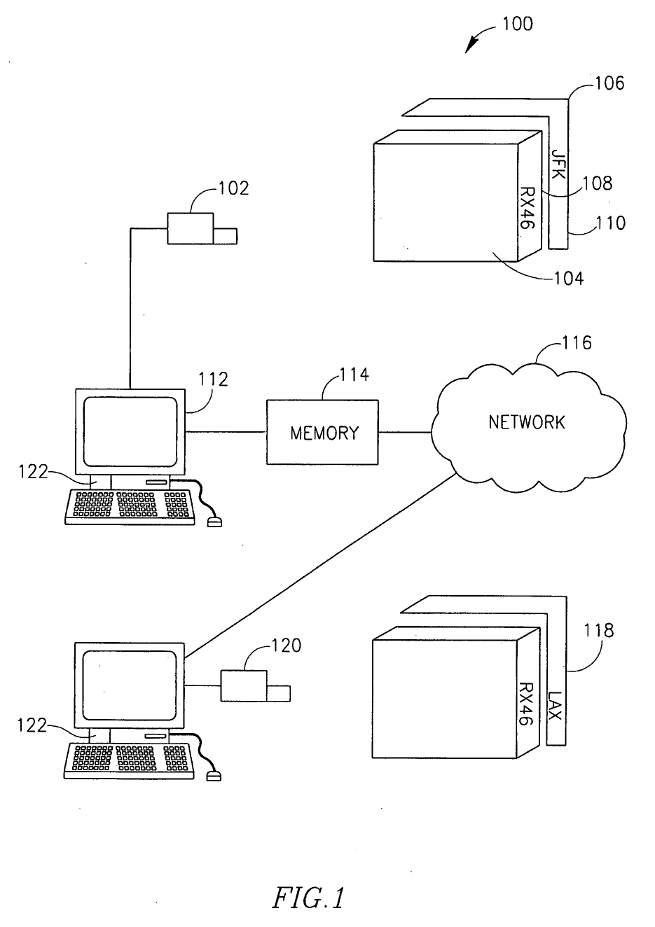

Reference is made to FIG. 1, a schematic depiction of a system in accordance with an embodiment of the invention. In some embodiments, a system 100 may include an image capture device or imager 102, such as an X-ray device, though other imaging modalities that may be suitable to capture an image or outline of objects that are held in a closed container, such as for example a shipping container 104, may be used. Examples of such other imaging modalities may include one or more of Infra-red, ultra-sound, CT, PET, MRI—and other 2D or 3D imaging methods. In some embodiments, imager 102 may be set in a fixed relative to container 104, such that an image of some or all of the contents of container 104 is captured as container 104 passes for example under or near the imager 102, such that the imager 102 may capture an image of the container 104 from a fixed and pre-defined position or orientation. In some embodiments, an imager 102 may be moveable, such as hand-held or part of a crane or loading system 106, and an orientation of the captured image may be varied from image to image and from container 104 to container.

In some embodiments, a container 104 to be imaged may be or include a standard-sized metallic shipping container of for example 20 feet or 40 feet, such as those that are used in overseas or overland shipping. In some embodiments, a container 104 may be or include a single box made of cardboard, wood or other material, or a palette of boxes or other packages that are wrapped or otherwise bundled together. In some embodiments, one or more of the items, boxes or packages in the container 104 may be identical, while in some embodiments, one or more of the contained items may be unique.

In some embodiments, a container 104 may include a unique identifier 108 that may be visible or discernible in the captured image. For example, (i) a wall or marking of a container 104 may include a unique number, letter or shape combination, (ii) a sheet, or sticker of metallic or magnetic material may be affixed to the container 104 inside or outside of the container 104, or (iii) a shape or configuration of the container 104 may be identified and used as a unique identifier 108 of the container 104 in the image.

In some embodiments, a unique identifier of a place or location 110 of the container 104 as it is imaged by an imager 102 may also appear in the captured image. For example, an imager 102 at a particular port, packing area or loading area may be positioned to capture an identifying mark, symbol or shape in the image of the container 1-4 that is captured.

In operation, a closed container 104 may pass near an imager 102 in a first location. The imager 102 may capture an image of the container 104, and the image may include an outline or discernible patterns or shapes of the items or objects in the container 104. In some embodiments, the image may also include one or more unique identifiers 108 of the container 104 and/or of the location 110 wherein the image was captured.

In some embodiments, the captured image may be transmitted for example to a computer 112 and/or loaded into a memory 114 that may be connected to or accessible by a network 116, where such image is associated with the imaged container 104. In some embodiments, one or more of the captured images may be associated with a bar code, RFID or other identifying number or symbol of the container 104. In some embodiments, image data may be encrypted with the one or more unique identification numbers of the container 104. In some embodiments video data, or other identifying data of the process of capturing the image may also be linked to the captured image of the contents of container 104.

Upon arrival of the container 104 at a second location 118, another or second image of the container 104 may be captured with a second imager 120. The second image may be compared with the first image in order to confirm that the contents of the container 104 have not changed or been tampered with. In some embodiments, the unique identifier of the container 104 and/or of the first location 110 may be confirmed in the image to prevent fraud and ensure the integrity of the imaging and imaging comparison process.

In some embodiments, coordinates of some, most or all of the contents of the container 104 in the first image may be compared to corresponding coordinates of the container in the second image. In some embodiments, an image may be rotated by a processor 122 to account for changes in an orientation of an imager between a first and a second location. In some embodiments, identified coordinates of items in a container 104 may be mapped against other coordinates of items to account for shifting or movement of items in the container 104. In some embodiments where a container 104 has numerous packages of the same or similar items, a pattern of the items may be discerned or isolated, and confirmation of the contents of the container 104 may achieved by tracking the pattern throughout the container 104.

In some embodiments, a first image as may be captured with a first imager 102 may be obtained at a location of a trusted shipper, or at another known location where the security and/or integrity of the imaging process may be confirmed. An image captured at such first location 110 may be uploaded onto for example secure network 116 or the Internet, and/or may be included in the shipping documents that accompany the container 104. In one or more subsequent locations through which the container 104 passes, additional images may be captured, and coordinates of items in the container 104 may be compared with those in one or more of the previous images. Similarly, identifying characteristics of the container 104 or location 110 of the imager 102 may be checked to confirm the integrity of the prior images. For example, a shipper or consolidator of a shipping container 104 may capture a first image, and load it onto the network 116. A dock may capture a second image, compare it to the first image to confirm the contents of the container 104, and load the second image onto the network 116. The receiving port or customs official may capture another image and compare it to one or more of the previous images to confirm the contents of the container 104 upon its arrival in a populated area.

The comparison application described may be more than just a local comparison application between two or more outputs of imagers. In some embodiments that comparison application may include a management application that can be connected from two or more imagers. In the case of managing multiple imagers, the management application may monitor multiple global shipment paths giving alarms or notifications for problematic shipments globally. It may include statistic features for grading the security level of the paths, alert on change in path's security level and generate global alerts or warnings when multiple events suggest an ‘attack’ that can be considered as a decoy.

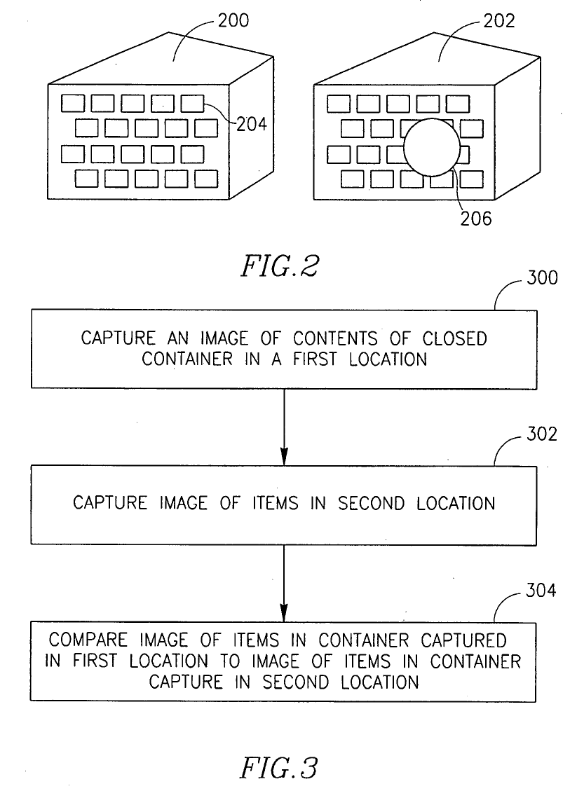

Reference is made to FIG. 2, a schematic diagram of two images of a container having objects 202 packed inside, in accordance with an embodiment of the invention. In some embodiments, a pixel to pixel comparison of the two images 200 and 202 may be undertaken as part of the confirmation process. In some embodiments, coordinates with known positions relative to the container 104 or to objects 204 within the container 104 may be located, and the comparison of the two images 200 and 202 may be executed by comparing the positions of objects in the container 104 relative to the positions of known objects in the container 104. In some embodiments, a foreign or unidentified object 206 may be detected in a second image 202 that was not present in a first image 200.

If a container 104 contains many units of a single product, an image of the unit could be uploaded and the software or its user could determine that the entire container 104 has only the designated unit and no other items. In some embodiments, orientation of the units could be compared to determine if the units had been unpacked and repacked. In some embodiments an X-ray of a single plane or selected plane of a container could be sufficient to determine if the contents match a prior X-ray of the container 104. In some embodiments an X-ray could be used to determine where and under whose control damage or loss occurred to contents of a container 104.

In some embodiments, a method of comparison of images from two containers may normalize correlation to compare to the images. This may compensate for intensity changes that may result from different machines used to capture the different images. Such approaches may require alignment of the two images. Image alignment may be pursued according to methods described in Hierarchical Model-Based Motion Estimation, Bergen J. R., Anandan, P., Hanna, K. J. and Hingorani, R., ECCV92; 1992; pages 237-252,

In some embodiments, imagers may generate a 3D output. In that case 3D registration may be pursued using one or more of the processes described in the Frameless registration of MR and CT 3D volumetric data sets (1994) Rakesh Kumar, Kristin Dana, P. Anandan, Nell Okamoto, Jim Bergen, Paul. In addition or alternatively methods may be used as are described in Yaron Caspi and Michal Irani, “Spatio-Temporal Alignment of Sequences”, in IEEE Trans. on Pattern Analysis and Machine Intelligence (PAMI), Vol(24) pp. 1409-1424, November 2002. A method that detects changes in object position within a container may be based on a description in Similarity by Composition, O. Boiman and M. Irani, Neural Information Processing Systems (NIPS), Vancouver, December 2006. Other methods for comparing and aligning images may be used

Reference is made to FIG. 3, a flow chart of a method in accordance with an embodiment of the invention. In block 300, an imager outside of a container may capture an image of items in the container, when the container is in a first location and where the container is closed. The image may be captured through a wall of the container by way of for example X-ray or other electro-magnetic, radio or other waves. The image may be stored in a memory and/or uploaded or made accessible over a network. The image may be associated in for example a data base with the container or with the items in the container.

In block 302, a second image of items in the container may be captured in a second location.

In block 304, all or a part of the items in the image of the container as was captured in the first location are compared to all or part of the items in the image of the container as was captured in the second location. A change in the items or a significant change in the location of the items in the container may be indicative of an unauthorized tampering with the contents on the container or an unauthorized addition to the contents of the container.

It will be appreciated by persons skilled in the art that embodiments of the invention are not limited by what has been particularly shown and described hereinabove. Rather the scope of at least one embodiment of the invention is defined by the claims below.

We claim:

1. A system comprising:
a first imager, suitable to capture an image of an item in a closed container, said first imager outside of said container, said first imager and said container in a first location;
a second imager, suitable to capture an image of said item in said closed container, said imager outside of said container, said second imager and said container in a second location; and
a processor to compare said image of said item in said container in said first location, to said image of said item in said container in said second location.

2. The system as in claim 1, wherein said imager comprises an X-ray emitter.

3. The system as in claim 1, wherein said container comprises a unique identifier that appears in said image captured by said first imager and said image captured by said second imager.

4. The system as in claim 1, wherein said container contains a plurality of said items and said processor is to identify if an item of said plurality of items appears in said image captured by second imager and does not appear in said in said image captured by said second imager.

5. The system as in claim 1, wherein said image captured in said first location is communicated to said second location over a network.

6. The system as in claim 1, wherein said image captured by said first images includes a unique identifier of said first location.

7. The system as in claim 1, wherein said processor detects from said image captured by said first imager a pattern of a plurality of said items in said container, and compares said pattern to said image captured by second imager.

8. The system as in claim 1, wherein said processor adjusts said second image to account for movement within said container of a plurality of said items in said container between said first location and said second location.

9. A method comprising:
capturing with an imager located outside a closed container in a first location, a first image of an item in said container;
capturing with an imager located outside a closed container in a second location, a second image of said items in said container;
comparing said first image to said second image; and
determining if items appearing in said second image were in said container in said first location.

10. The method as in claim 9, wherein said capturing said first image comprises collecting an X-ray image of said container.

11. The method as in claim 9, wherein said capturing said first image comprises capturing in said image a unique identifier of said container.

12. The method as in claim 9, comprising associating in a data base, said first image with said container, and making said image accessible to an operator at said second location.

13. The method as in claim 9, wherein said capturing said first image comprises capturing in said first image a unique identifier of said first location.

14. The method as in claim 9, comprising detecting in said first image a pattern of a plurality of said items in said container, and finding said pattern in said second image.

15. The system as in claim 9, comprising adjusting said second image to account for movement within said container of a plurality of said items between said first location and said second location.

16. An article comprising a memory, having stored thereon instructions that when executed result in:
retrieving from a network, a first X-ray image of an item inside a closed container, said image associated with a unique identifier of said container, said image captured at a first location;
comparing said first image to a second X-ray image of said item inside said closed container, said second X-ray image captured at a second location.

17. The article as in claim 16, wherein when executed said instructions compare a unique identifier of said container as appears in said first image to said unique identifier of said container as appears in said second image.

18. The article as in claim 16, wherein when executed said instructions compare a unique identifier of said first location as said unique identifier appears in said first image to a routing of said container.

19. The article as in claim 16, wherein when executed said instructions account for movement within said container of a plurality of items in said container, said movement of said items occurring between said first location and said second location.
